(19) United States
(12) Patent Application Publication
(10) Pub. No.: US 2002/0009345 A1
(43) Pub. Date: Jan. 24, 2002

(54) CARGO CONTAINER

(76) Inventor: MARTIN CLIVE-SMITH, WOOTTON PADDOX (GB)

Correspondence Address: LACKENBACH SIEGEL MARZULLO ARONSON, & GREENSPAN, PENTHOUSE SUITE, ONE CHASE RD, SCARSDALE, NY, 10583

(21) Appl. No.: 09/181,156

(22) Filed: Oct. 28, 1998

(30) Foreign Application Priority Data
Oct. 29, 1997 (GB) 97 227 89.6

(51) Int. Cl. B60P 7/12

(52) U.S. Cl. 410/32

(57) ABSTRACT

A dedicated (log) cargo container (10), for loosely stacked (log) cargo 16, has a load bed (20), with longitudinal chassis rails (11, 12), surmounted by folding corner end posts (14, 15), for mutually-supportive, stacking inter-fit, with other containers, and multiple intervening lateral restraints (18), individually (re-) movable, or foldable longitudinally or laterally, to lie folded within the footprint of the load bed: allowing overall container collapse unladen, and container stacking inter-fit, either laden or unladen and collapsed; opposed lateral restraints may be braced, by a transverse (load support) beam (19), in an integrated foldable U-frame (3C).

### This invention relates to containers, and is particularly, but not exclusively, concerned with the containerisation of multiple discrete (elongate) load elements.

Load elements may exhibit a certain superficial general commonality, if not uniformity, of character, yet admitting some individual diversity in shape and size.

Such multi-element loads present particular restraint problems in stack form, not least the tendency of individual load elements to move, for example roll, over one another, disturbing and even collapsing the stack.

Countering stack spread presents lateral restraint loads, in addition to bearing the passive downward stack weight.

Containerising such, otherwise loose-stacked, elemental loads thus imposes lateral loads upon container walls, for load confinement or enclosure which are not generally provided for in typical thin-(panel) wailed closed container design.

Such lateral loads risk container wall bending or bulging, and overall profile distortion, breaching the very standardisation of shape and size of the underlying concept of containerisation.

Both closed and open-sided, general-purpose, containers are known, along with containers ‘dedicated’ to particular loads.

Broadly, containerisation addresses the conformity of overall load profiles and payload tare to prescribed standards—enabling a uniform modular approach to transport and storage, despite inherent load disparity.

Some aspects of the invention are concerned with the ‘dedicated’ containerisation of timber, in particular as ‘raw’ logs, for bulk shipment.

However, the invention is applicable to other loads, especially those, such as poles, pipes or drums, with similar (curved or rounded cross-sectional profile) character and stacked behaviour to logs.

Broadly, the intention is to allow conformity with international containerised freight standards and compliant inter-fit with other containerised loads, whether logs or otherwise, for mixed shipment.

Dedicated or bespoke road and rail transport vehicles, whether trailers, carriages or wagons, are known for the bulk carriage of relatively long, slender loads, such as log cargoes.

Typically, such vehicles are used to freight logs in bulk from at or near a logging site, where they are felled, to a remote timber processing plant, where they are sawn up and converted into timber sections.

Generally, logging vehicles employ a minimal open lattice frame construction, for example with incrementally-spaced lateral support struts, along a common central longitudinal chassis spine.

Opposed lateral struts may be linked by a transverse beam, as a U-profile, braced restraint. Lateral bracing is generally secured at fixed positions along the chassis rails. However, an occasion, some longitudinal adjustment provision has been incorporated—albeit at greater constructional complexity and attendant cost

It is also known to fit extendible and removable lateral bracing posts—but their bulk, weight and so strength are constrained by manual handling considerations.

Generally, the robustness and span of lateral restraint members reflects a construction compromise, to reduce unladen dead-weight and increase loading capacity, for given axle and permanent-way limits.

A relatively unobstructed loading profile and flexibility in loading and unloading regimes are desirable.

The scope for overall dimensional variation, under static and dynamic loading, is more limited with rail carriages or freight wagons, to avoid collisions with trackside equipment or infra-structure, such as tunnel walls or bridge piers, than with, say, road trailers. This dictates a certain inherent structural integrity, to avoid undue frame flexing or distortion upon loading and in load transportation.

However, these road and rail vehicles have not been containerised as such, nor of a design configuration directly suitable for standardised containerisation. That is the bespoke approach has addressed individual discrete loading requirements, rather than multiple load compatibility or selective inter-fit, such as with stacking and nesting of multiple container profiles.

In particular, dedicated logging trailers, wagons or carriages have had no facility for self-collapse, into a compact form, when unladen or empty. Nor has there been provision for tiered stacking of multiple individual collapsed structures within an individual container profile, such as for economic space reduction upon a ‘return-empty or unladen’ journey.

According to one aspect of the invention an elongate load (eg log) cargo container comprises

a load bed,

a plurality of lateral restraints,

selectively mountable upon the bed.

The load bed may comprise one or more longitudinal chassis members or rails, with occasional transverse members supporting lateral or side restraint members.

Thus one variant has a pair of spaced chassis rails with intervening transverse spacers in a ladder frame configuration.

Another variant has a single chassis spine, with transverse members configured as branch stubs on either side again supporting lateral restraint members. This provides ample load underside access.

Transverse members could be located somewhat below the longitudinal chassis depth, to create a recessed or underslung load carrying bed or support layer.

Lateral restraint members could be hinged, pivoted or removable, either individually, or entrained with an associated transverse stub member, for selective rotation between retracted and elevated or upright positions.

In the retracted positions, the lateral restraint members are desirably contained within, or somewhat underlie tine upper level of, the longitudinal chassis rail depth.

Desirably, the lateral restraints are fitted in (transversely) opposed pairs; for example along opposite bed sides. In that case, a transverse bracing member advantageously spans across the bed, between opposed restraints, at, or marginally above or below one or more longitudinal chassis members or rails.

Preferably, whatever chassis configuration adopted, a load bed or load support platform and the erected or collapsed span of any end posts, transverse support beams, and lateral restraints fit collectively within, or are bounded to conform to, a prescribed overall containerisation load envelope standard, for stacking and/or inter-nesting inter-fit with other similar such containers, either when erected or collapsed.

Transverse bracing may comprise a (tension) tie rod, wire or chain, between the lower ends of opposed restraints. Such a tie helps relieves the restraint mounting loads to a load bed.

The tie may incorporate provision, such as a turnbuckle, for tension adjustment.

Alternatively, the restraints may be interconnected by a rigid transverse beam, in an integrated, unitary U-frame assembly. In practice a corner bracing plate might be fitted between transverse beam and adjoining lateral restraint member ends.

The transverse beam could be movable, between a plurality of spaced fittings on the restraint uprights.

Transverse beam location near the restraint upright bending centres helps resist bending under lateral spreading loads of a stacked, and otherwise loose, cargo of multiple discrete elements, such as logs.

The restraints may be telescopically adjustable in length, for diverse load heights when erected and for compactness when folded.

The restraints are desirably collapsible upon or alongside the load bed, according to the longitudinal chassis rail configuration. Thus, for example, the restraints may be pivoted to allow erection into an upright load restraint condition in relation to the load bed and collapse into a folded condition, lying generally alongside tho load bed.

A transverse pivot axis (for longitudinal restraint folding) between opposed longitudinal chassis rails of a load bed allows a common pivot axle or axially-aligned individual pivot bearings in respective chassis rails.

Either longitudinally or transversely folding supports may be accommodated on the bed.

Longitudinal folding allows supports to be erected or lowered in opposed pairs, with a transverse bracing member there-between remaining in place.

Selectively releasable latching or locking provision between the supports and base could secure the supports in either the erected or collapsed (lowered) is conditions.

Locating and load bracing abutments could be fitted to the load bed for the restraints, along with alternative (pivot) mountings, to allow restraint relocation along the bed.

The base section is typically deep to afford the necessary overall load-bearing strength and rigidity and, when lowered, the lateral restraints are conveniently accommodated within that depth.

Thus, the collapsed container height approximates to or even equates with the base depth.

The restraint mountings conveniently take advantage of the base depth in bracing those supports.

In a particular construction, a U-profile transverse restraint beam assembly is mounted upon localised opposed pivot bearings in longitudinal chassis rails of a load bed.

*Angled internal corner bracing plates may be fitted between restraint uprights and transverse beam to help withstand lateral spreading loads on the uprights.

Such corner plates, and in particular their diagonal inward edge, also help locate a rounded log profile in the lower layer of a stacked log cargo.

Corner plates may be secured at an angle to the respective side edges of restraint uprights and transverse beam, to allow longitudinal folding of the integrated assembly upon load bed longitudinal chassis rails, through an angle of somewhat greater than 90 degrees.

The folded assembly then lies orientated marginally below the horizontal allowing (partial) overlying of another successive U-frame assembly, in a longitudinal stacking sequence.

Selectively operable restraint latches are fitted between lower ends of the lateral uprights of the beam assembly and lower edges of the chassis rails.

The transverse beam bridging opposed lateral uprights can be accommodated between the chassis rails in the lowered or collapsed condition, with the lateral members lying generally above, alongside or between the chassis rails.

Recesses may also be provided in the upper edges of the chassis rails, to accommodate at least some of the cross-section of a transverse bracing beam.

Alternatively—or indeed additionally—recesses can be formed in the U-section frames to accommodate the chassis rails.

When multiple sets of longitudinally-spaced, lateral restraint sets are folded longitudinally, a mutually overlying, longitudinal stacking configuration may be adopted.

When stacked, the folded restraints may lie upon, alongside or partially or wholly below the top edge of and within the vertical depth of the longitudinal chassis rails, according to their respective pivot positions.

In one preferred pivot configuration, connecting plates between restraint uprights and opposite ends of the associate transverse bracing beam lie on top of the respective chassis rails.

To assist stacking when folded, some restraint sets may be mounted and configured to fold through a marginally greater angle.

Thus, for example, a fold angle of some 110 degrees—as opposed to merely 90 degrees—may be employed, to translate from an upright/vertical to a (below) horizontal folded condition.

An alternative folding orientation for lateral load restraints is transversely.

In this case, given a typical restraint height up to an allowed overall container depth, and/or container chassis width, provision for stacking or overlying transversely folded restraints is desirable, to keep the folded restraints below the upper edge of and within the depth of the longitudinal chassis rails.

The restraint depth is desirably less than the transverse span of opposed chassis rails supporting the load bed—although again telescopic restraints are feasible, albeit with additional complication.

The transverse pivot points are conveniently within the depth of the chassis rails, but close to the restraint centre of gravity.

Tapering the top end and bulking the lower end of a restraint with pivot mounting brackets and latching fittings helps lower a restraint centre of gravity.

Moreover, the higher the transverse pivot points, the less lateral bending load upon the restraints through the spreading tendency of multiple (otherwise loose) stacked cargo elements, such as logs.

In either transverse or longitudinal fold orientations spring bias, or gas strut preloading, may be incorporated to assist manual erection, by carrying and cushioning a portion of residual folded restraint weight,

Folding aside, the lateral restraints may be demountable, either when upright or when folded generally horizontal.

Moreover, a combination of folding and demountable or (re-)movable restraints may be relied upon.

Multiple mountings may be fitted to the load bed, for example on longitudinal opposed supporting chassis rails, to accommodate (re-)movable, and optionally foldable, restraints.

In a particular construction, some three sets of multiple discrete elongate loads, such as logs, pre-cut to within prescribed lengths, are disposed in self-contained longitudinally-spaced stacks, each with a pair longitudinally-spaced lateral restraints, disposed in laterally opposed pairs, a preferred restraint pair spacing being some 3 metres.

At, or adjacent, the corners of a container chassis, end supports and load lateral restraints may be integrated into an element of supplementary width.

Nevertheless, integrated end supports and lateral restraints may also be folded transversely or longitudinally of the longitudinal chassis rails, for overall container collapse and stacking inter-fit.

An advantage of transverse folding of corner posts is that their width longitudinally is not a material constraint, but is merely translated into cargo load overlap.

Dedicated corner post locking or locating of a log cargo at lower stacking levels is not critical.

An end gate may be fitted between corner posts at either one or both ends of the load bed, for load restraint.

Such gates may be demountable altogether, and/or hinged at the base or from one side, to allow supported opening and closing for load access.

The or each longitudinal chassis rail may be recessed to accommodate a folded over end gale within the overall chassis depth—preserving a compact collapsed configuration, for ease of tiered stacking.

The load platform or deck of the load bod may also be recessed or profiled to allow load cargo elements to lie between the chassis rails—as opposed to merely upon a load deck surmounting the chassis rails.

Such a recessed load bed:

increases the overall load capacity somewhat;

lowers the load centre of gravity; and

relieves the lateral spreading loads of a loose cargo on the restraint uprights.

Thus, for example, a trough-section load floor profile may be adopted, with either a continuous floor panel or merely spaced transverse members.

A rectangular-section trough profile may be adopted, allowing load elements to lie between chassis members over a substantial portion of the transverse chassis span.

Alternatively, a shallow V-section gutter profile, allows the load elements to sit progressively deeper between the chassis rails towards the chassis longitudinal axis.

Similarly, for load restraint, particularly with rounded-section load elements susceptible to unstable shuffling movement, some complementary profiling of the load support deck members—and indeed the load engaging inner edges of lateral restraints—may be incorporated.

Generally, consideration of the load distribution within the load can allow some of the triangulated stacking and spreading loads to be reacted downwards and so contained within the load itself—thus imparting greater load stability and reducing the onus upon the lateral restraints.

There now follows a description of some particular embodiments of the invention, by way of example only, with reference to the accompanying diagrammatic and schematic drawings, in which:

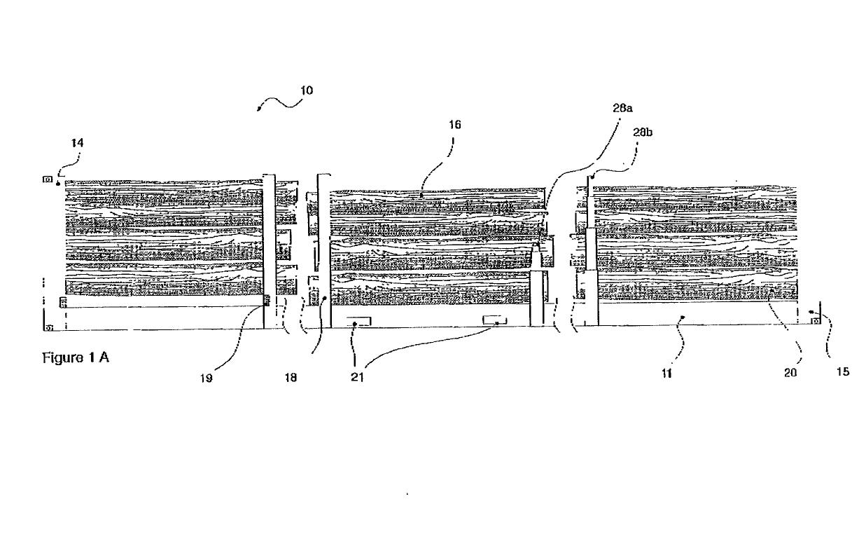

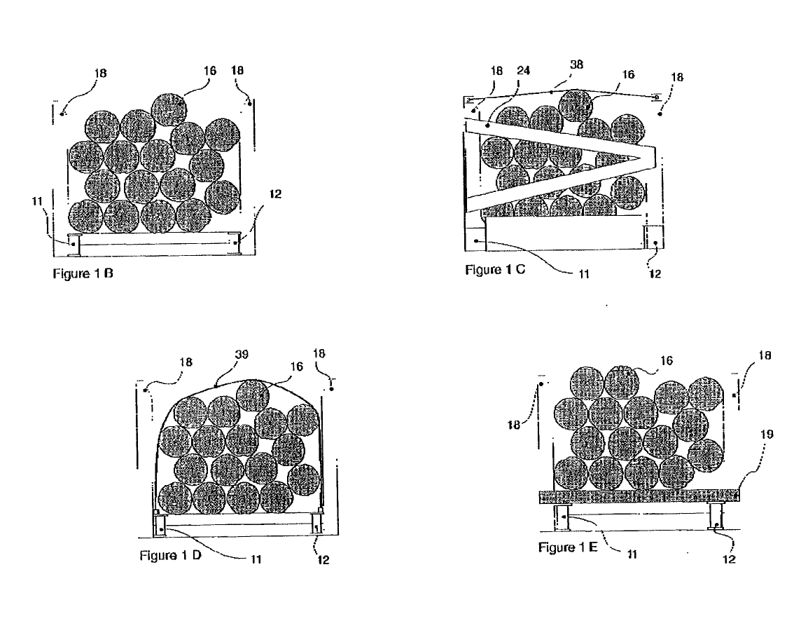

FIG. 1A shows a side elevation of a loaded log container with a chassis constituted by a pair of longitudinal rails, with intervening transverse spacer or bracing members and lateral load restraints, carried thereby or mounted directly to a longitudinal chassis member;

FIG. 1B shows an end elevation of the loaded log container of FIG. 1A;

FIG. 1C shows, in end elevation, an end gate fitment for the loaded log container of FIGS. 1A and 1B;

FIG. 1D shows, in section, a transverse load restraint tie for the loaded log container of FIGS. 1A through 1C;

FIG. 1E shows, in section, a combined load bed elevating beam and transverse brace between lateral restraints, for the loaded log container of FIGS. 1A through 1D;

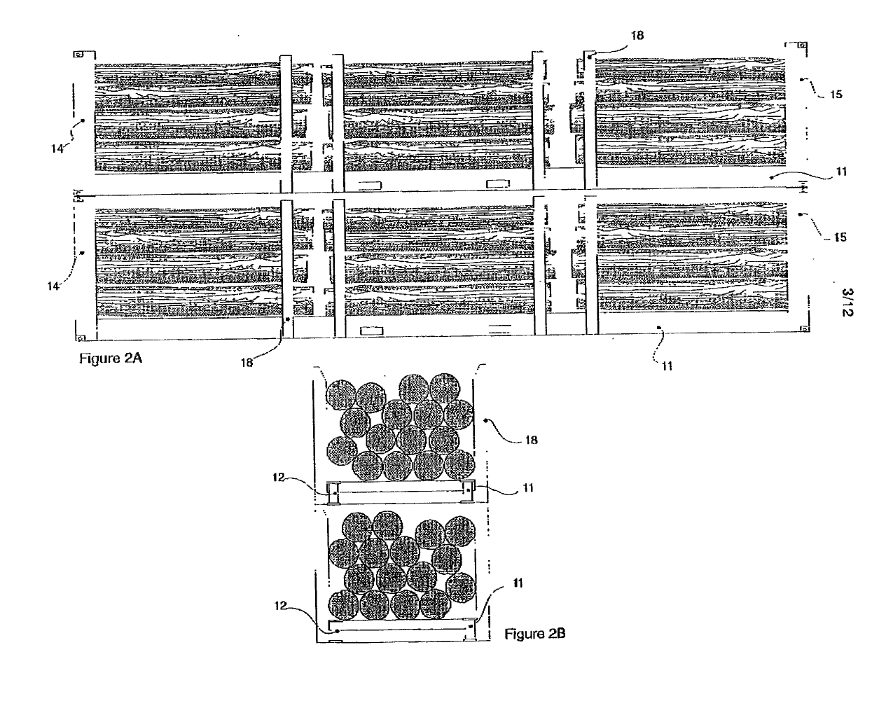

FIG. 2A shows a side elevation of two loaded containers of FIGS. 1A and 1B stacked, one upon another;

FIG. 2B shows an end elevation of the stacked containers of FIG. 2A;

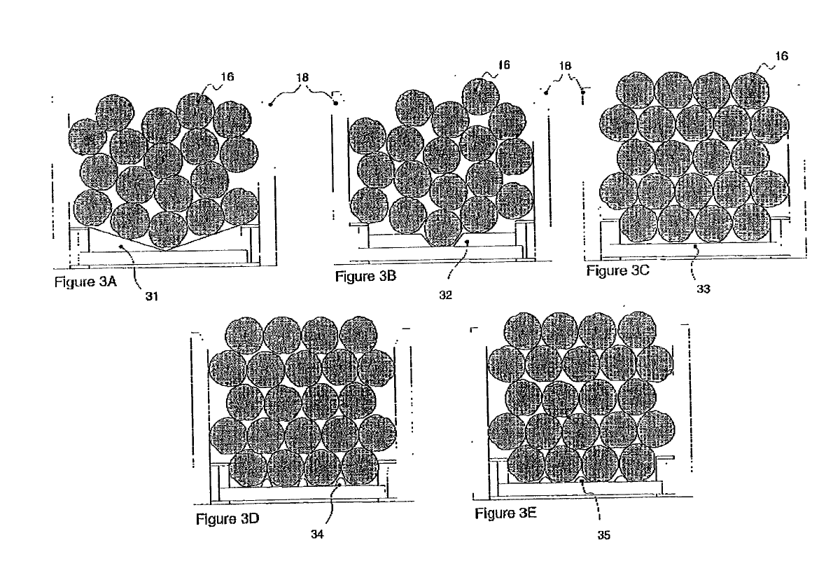

FIGS. 3A through 3E show lowered-level load stacking variants for the container of FIGS. 1A and 1B;

More specifically;

FIG. 3A shows a V-section recessed load deck;

FIG. 3B shows a notched recessed load deck;

FIG. 3C shows a shallow rectangular load deck trough;

FIG. 3D shows a profiled load deck;

FIG. 3E shows an alternative profiled load deck;

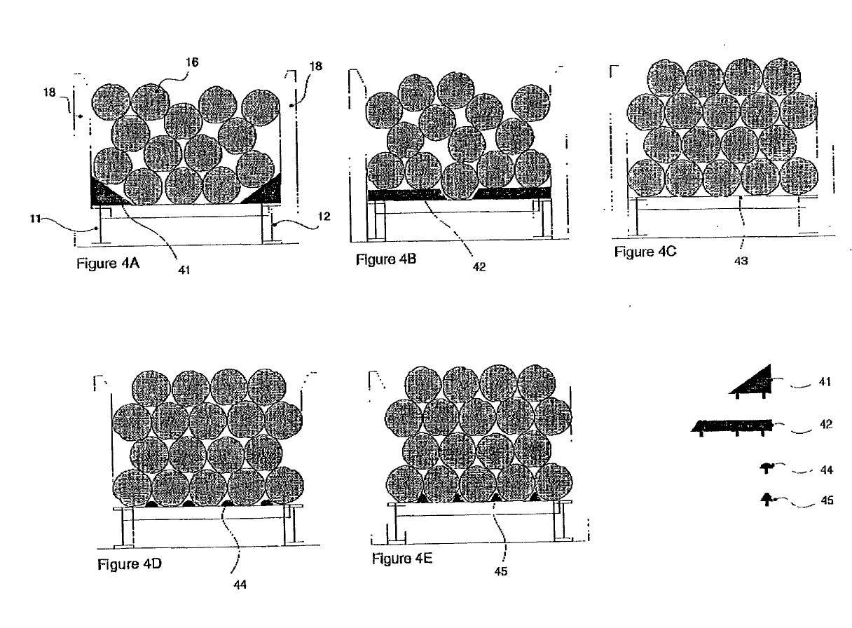

FIGS. 4A through 4E show further load stacking variants upon a regular deck level;

More specifically:

FIG. 4A shows an elevated load deck with lateral bracing wedges;

FIG. 4B show a notched elevated load deck;

FIG. 4C shows a full-width elevated load deck;

FIG. 4D shows a profiled elevated load deck;

FIG. 4E shows an alternative elevated load deck profile;

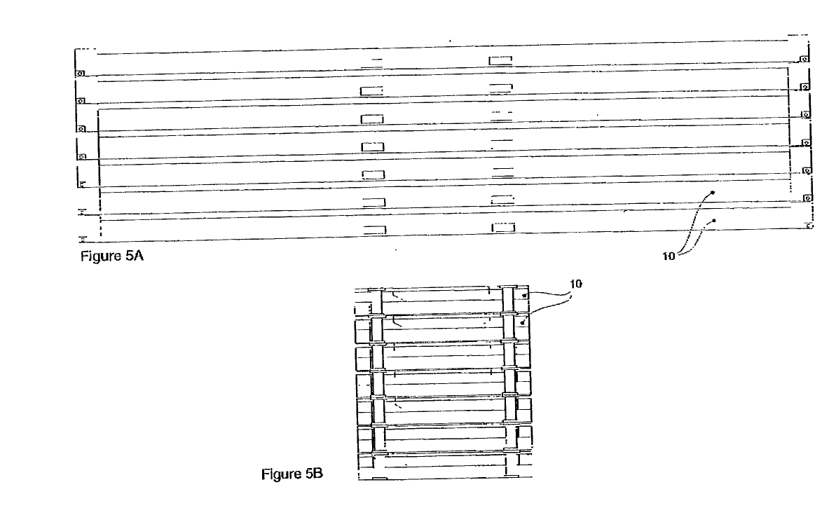

FIG. 5A shows a side elevation of multiple stacked, (unladen) collapsed containers;

FIG. 5E shows an end elevation of FIG. 5A;

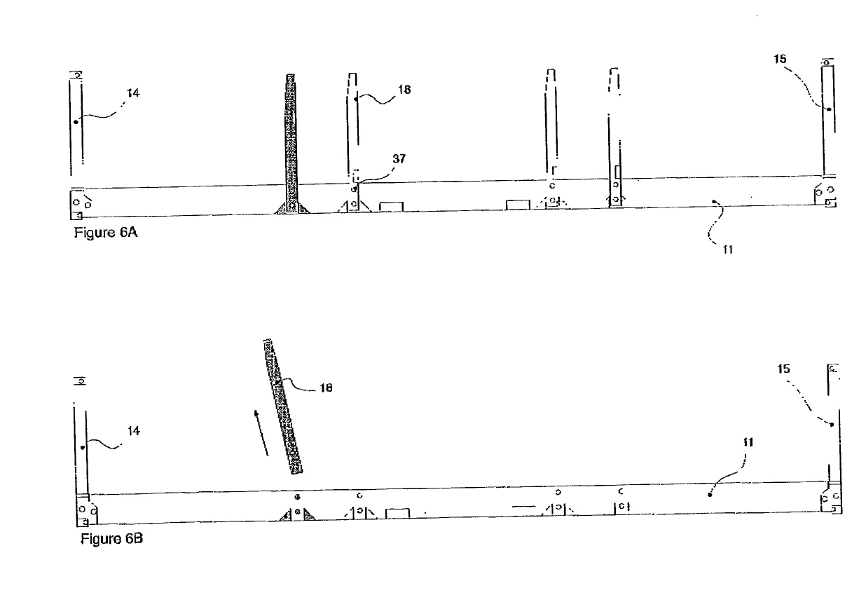

FIG. 6A shows a side elevation of an unladen container with demountable lateral restraints:

FIG. 6B show restraint removal for the container of FIG. 6A;

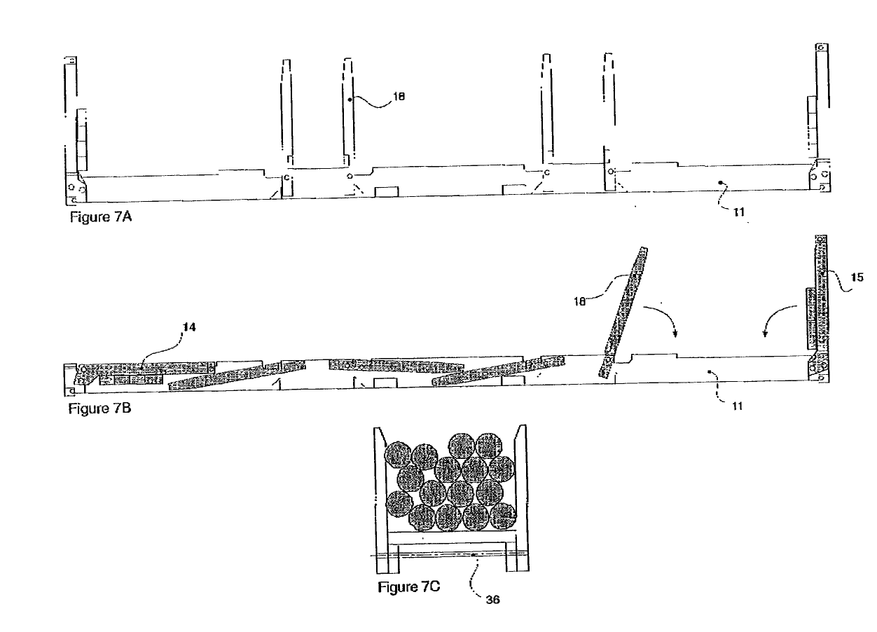

FIG. 7A shows a side elevation of an unladen container with longitudinally-foldable lateral restraints in an erected condition;

FIG. 7B shows progressive folding of the lateral restraints of the container of FIG. 7A;

FIG. 7C shows an end elevation or transverse section of the container of FIG. 7A laden with logs upon transverse dock beams; between opposed lateral restraints mounted upon a common pivot axle through load bed chassis rails;

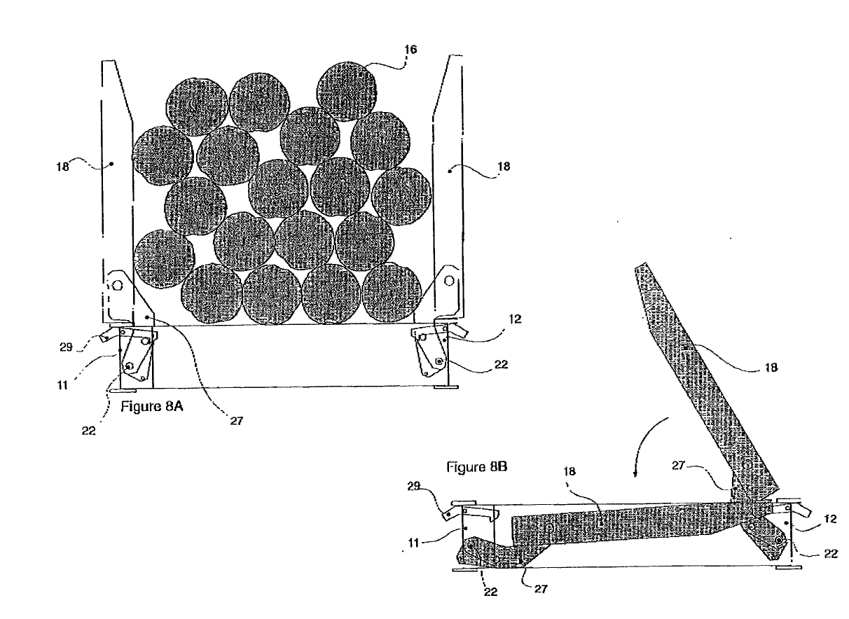

FIG. 8A shows an end elevation or transverse section of transversely foldable lateral restraints in an erected condition;

FIG. 8B shows progressive folding or transverse collapse of the lateral restraints of FIG. 8A;

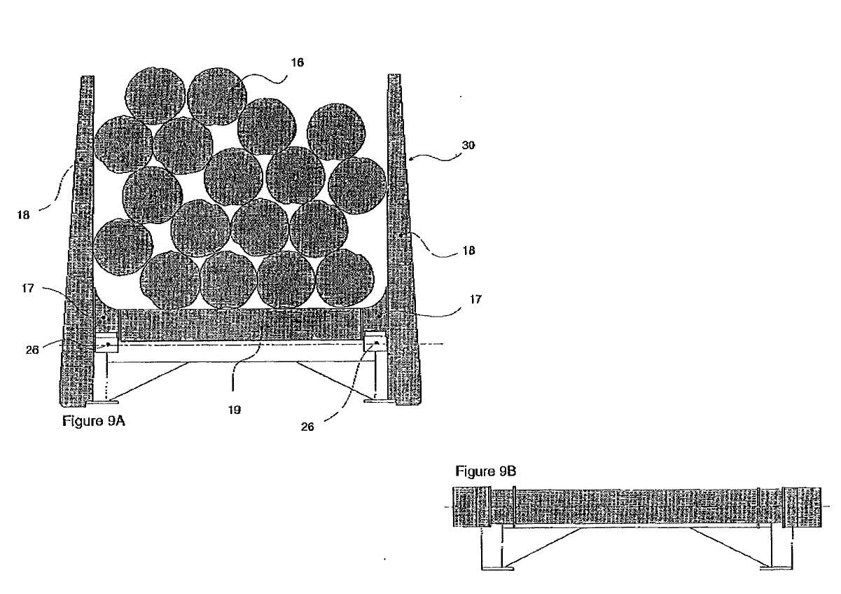

FIG. 9A shows an end elevation or transverse section of longitudinally foldable lateral restraints in a transversely braced U-frame assembly;

FIG. 9B shows a folded or collapsed view of the lateral restraint assembly of FIG. 9A;

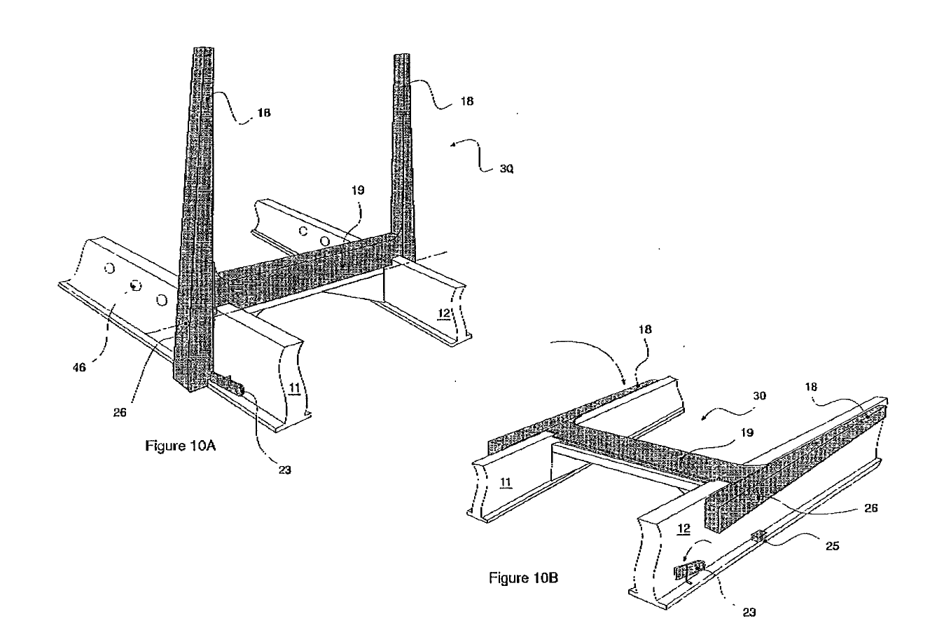

FIG. 10A shows a perspective view of the erected U-frame lateral restraint assembly of FIG. 9A;

FIG. 10B shows a perspective view of the folded or U-frame lateral restraint assembly of FIG. 9B;

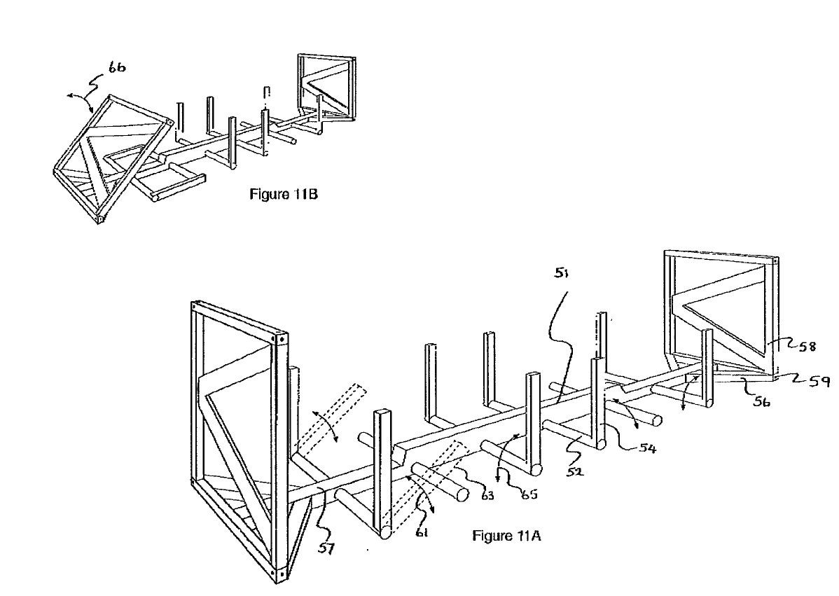

FIG. 11A shows a single central spine chassis variant; and

FIG. 11B shows the variant of FIG. 11A with an end gate partially folded over.

Referring to the drawings, a dedicated container 10 for (otherwise loose) log cargo 16 comprises a load bed 20, with a series of longitudinally-spaced lateral restraints, in the form of upright posts or struts 18, between corner end posts 14, 15, at or adjacent the ends of the load bed 20.

The load bed 20 is of generally open lattice construction and incorporates a pair of spaced longitudinal deck beams or chassis rails 11, 12 extending between, or somewhat beyond, corresponding corner posts 14, 15.

A cargo load, in this case logs 16, is supported upon an open lattice of transverse deck beams 19 running between the chassis rails 11, 12.

Deck inter-fill or cladding over the entire load bed 20 is unnecessary for bulk loads, such as logs, which can span spaced deck beams and have sufficient inherent structural integrity, but partial lining for operator walk-ways may be fitted.

An open lattice construction helps reduce container weight and increase payload capacity. The container 10 as a whole generally shares the open-sided, lattice or space frame construction of the load bed 20, although lightweight side cladding, such as fabric curtain walling might be fitted for load security.

The container 10 is collapsible to a shallow load bed profile—allowing flat-pack storage and transport when unladen, within the container footprint.

The container 10 is configured for complementary stacking inter-fit with other containers, for example in a compact vertical stack with other containers, both erected and laden and collapsed unladen,

A two-tiered stacking example, of erected and loaded containers, is depicted in FIGS. 2A and 2B. An alternative fully collapsed, unladen, multiple container stack is depicted in FIGS. 5A and 5B.

Generally, stacking of erected containers 10 relies upon corner end posts 14, 15, which are of a more robust construction than intervening lateral restraints 18, and extend to the full container height.

Provision is made for collapsing a container 10, by folding or removing intermediate lateral restraints 18 and folding corner end posts 14, 15.

In the various folding options, the folded posts 14, 15, and restraints 18 could lie above, alongside or partially or wholly below and within the depth of the chassis rails 11, 12, for minimal profile within a container foot-print.

Broadly, if not (re-)movable altogether, the restraints 18 are either foldable longitudinally, to lie alongside the chassis rails 11, 12, or transversely, to lie between them.

For lateral bracing, the lower ends of the erected restraints 18 are fitted to the (outer) side walls of chassis rails 11, 12, through connector pins 37, as shown in FIGS. 6A, 6B.

The height of the restraints 18 reflects the maximum cargo loading height, and may not extend to the full overall container (envelope) height.

Height adjustability may be incorporated for individual restraints 18, for example through a telescopic construction 28a (retracted), 28b (extended).

A linkage (not shown) may be fitted between lateral restraints 18—desirably at or below load bed 20 level, so as not to obstruct load access—to enable them to be raised (erected) or lowered together. Such a common linkage could operate all the pivoted restraints 18 on one side of the load deck.

An independent common linkage could be provided for all the pivoted restraints 18 on the other side of the load deck. Alternatively, through a cross-linkage, restraints 18 on both sides of the load deck could be operated together. Power drive assistance could be provided for multiple restraint 18 operation.

The restraints 18 are subject to considerable lateral spreading loads, as in an otherwise loose stack of individually heavy and bulky cargo load elements, such as logs. The restraint 18 to chassis rail 11, 12 mounting (37) is thus critical.

Lateral spreading loads may be countered by locally tying together opposed restraints. Thus, for example, a flexible upper tie wire, cable, chain or belt 38 may be fitted over the load between the upper ends of opposite restraints 18, as shown in FIG. 1C. Alternatively, the entire load girth may be enveloped in a tie wire cable, or chain 39, with opposite ends secured to mountings on the chassis rails 11, 12 as shown in FIG. 1D.

These load ties are essentially temporary restraint measures, and may be supplemented with, or substituted by, more permanent measures. Thus the restraints 18 are conveniently grouped in laterally-opposed pairs, with a permanent intervening transverse bracing beam 19, in an integrated, stiffened, unitary U-frame assembly 30.

A profiled corner joint plate 17 could be fitted at the junction of the beam ends and the restraints 18, to help locate a lower layer in a load stack. The corner joint plates 17 could also define a folding limit by abutment with the upper edge flanges of the chassis rails 11, 12.

Successive (transverse) beams 19 collectively define a load bed 20 level, which may be set above, at, or below chassis rail upper edge level.

An individual U-frame So may be foldable longitudinally in its entirety. Thus, opposite lower ends of the lateral restraint posts 18, at or below the cross-member or transverse bracing beam 19, could be mounted in opposed, axially-aligned pivot bearings 26, set in respective chassis rails 11, 12.

As an alternative to individual pivot bearings 26, a common transverse pivot shaft 36, as shown in FIG. 7C, spanning the chassis rails 11, 12, could be employed for pivot mounting of opposed restraint posts 18.

However, individual post-to-chassis rail pivot mountings at each side of the load deck may be preferable, to avoid obstructing load access, and given the provision of a transverse bracing beam inherent in an integrated U-frame construction.

Selectively deployable restraint latches 23 are provided to hold the restraints upright and spring bias or gas loaded struts (not shown) can be fitted to assist manual (re-)erection.

An alternative, transverse folding, lateral restraint construction is shown in FIGS. 8A and 8B. Opposed posts 16 each have a lower offset hinge bracket 27, mounted in pivots 22 upon respective chassis rail 11, 12.

A releasable latch 29 fitted to the chassis rail 11, 12 is deployable automatically upon bringing the restraint 18 into an upright condition, so that its lower end sits upon the upper flange of the chassis rail 11, 12. When folded between chassis rails 11, 12, the restraints 18 (marginally) overlie one another, within the base deck section.

A combination of folding and removable mounting may be provided for restraint posts, struts or frames—allowing re-disposition along the chassis rails 11, 12 according to a particular loading configuration on the load deck. The chassis rails 11, 12 could accommodate supplementary mounting fittings 46 to this end, used selectively, according to the number and spacing of lateral restraints 18.

However, foldable or demountable, lateral restraint posts or struts 18 may be tapered towards their upper ends, allowing a certain degree of outward bending spray upon loading, without breaching the prescribed container profile.

Demountable or movable end walls, barriers or gates 24 could be installed between corner posts 14, 15 at one or both ends of the load deck 20. Such end barriers 24 would serve as a buffer against forward or rearward load shift under braking or acceleration—advantageous for road or rail transport. Thus, a hinged end barrier or gate 24 could be swung open for load access, particularly in manoeuvring logs suspended from an overhead crane.

The relative dispositions, and in particular the degree of inter-nesting, of logs 16 in a bundled log load can vary, given their generally rounded, yet irregular, individual profiles and surfaces; and a degree of ‘natural settlement’ may be allowed.

FIGS. 3A through 3E and FIGS. 4A through 4E show various log stacking and inter-nesting configurations. Logs 16 subject underlying logs to downward and sideways reaction forces at opposed contact points on their lower surfaces.

A net diagonal outward thrust must be countered by an inward lateral restraint. Absent lateral restraint, an otherwise loose log stack is laterally unstable and tends to splay sideways, leading to eventual collapse. Stack disposition upon a recessed trough or loading well laterally restrains and stabilise the lower stack layer—and so progressively at least the inner cares of the upper layers.

More particularly, the shallow inward inclined V-section base deck trough 31 of FIG. 3A, which may be formed by incrementally-spaced transverse deck beams between longitudinal chassis rails, generates opposed inwardly-directed reactions, to brace the stack.

A notched base deck profile 32 of FIG. 3B merely restrains a single innermost 40 log in the lower stack layer—although the outermost logs in that layer rest upon opposed abutment ledges formed by tho longitudinal chassis rails.

Lateral base deck restraint is more pronounced in FIG. 3C, with the entire lower log layer effectively confined within a shallow tray or trough 33 between longitudinal chassis rails.

A similar confinement is used in FIGS. 3D and 3E, but with supplementary interstitial log spacer elements 34, 35 of complementary inter-fitting profile—those in FIG. 3D being more pronounced than the more rounded semi-circular spacers of FIG. 3E.

FIGS. 4A through 4E show corresponding load lower layer restraints 41, 42, 44, 45 to the elements 31, 32, 34, 35 of FIGS. 3A through 3E respectively, but deployed upon base deck beams surmounting longitudinal chassis rails 11, 12, giving a wider lower layer span, albeit with a higher load centre of gravity.

The load layer restraints 41, 42, 44, 45 may be removable inserts—with optional storage and stacking provision elsewhere in the container deck when not in use. Similarly, demountable lateral restraints, as shown in FIGS. 6A and 6B, may be stored elsewhere—say between the longitudinal chassis rails, when not in use.

FIG. 6A shows a demountable lateral restraint post or strut, slotted in place between opposed lateral abutments fitted to a chassis rail lower side wall. Optional locating and/or locking/latch pins 37 interact with the lower strut body. FIG. 6B shows strut removal, which may be effected manually, once unlatched.

The strut 18 depth may be marginally less than that of the corner end posts 14, 15 defining the overall container height profile, so stacking loads are not carried thereby, although their presence may limit or serve as a backstop for bending of chassis rails 11, 12 of a surmounting container. Struts 18 may thus be removed or inserted even when the container 10 is stacked.

Opposed struts 18 could be joined by a transverse bracing beam, in an integrated U-frame assembly, removed or inserted in a single, albeit somewhat more cumbersome, operation.

The longitudinally disposed log payload 16 can be loaded or unloaded from either side of the container 10, by lowering or removing the lateral restraints 18 on that side—for at least an equivalent longitudinal span.

A fork lift truck (not shown) with appropriately configured opposed jaws may be used to carry individual or clustered logs 16 over the longitudinal chassis rails 11, 12. The load bed 20 can be configured to allow operating clearance for fork lift tines.

For load integration, and as a supplementary lateral restraint, sharing the burden upon lateral restraint posts, log bundles may be secured together with, say, tensioned rope, wire, belt or chain ties 39, as shown in FIG. 1D.

Thus, for example, the load bed 20 could be raised marginally above the longitudinal chassis members 11, 12, for example by transverse deck beams 19, to provide operating clearance for the fork lift tines, operating laterally.

Alternatively, an angled tine approach angle, requires clearance in and below the bed, allowing tines to plunge between a chassis rail 11, 12 and cargo 16, and tine rotating to collect and extract a portion of the cargo 16.

The container 10 can accommodate diverse and mixed loads—and the intermediate load restraints 18 substituted or adapted accordingly.

Folded or demounted and stored restraints 18 could themselves form supplementary cargo supports, above, flush with, or below the chassis rails 11, 12. Thus, say, a partial log load may be combined with other loads.

Slots 21 may be incorporated in the side wails of the longitudinal chassis rails 11, 12 for fork lift truck tines—enabling container handling and stacking, particularly when unladen and collapsed.

Although logs have been depicted lying longitudinally along an elongate load bed or chassis members, other load configurations are possible.

Comparable load elements to logs, such as pipe sections, tubes or drums, may be transported in a similar fashion. However, load regularity would enable preconfigured packing and clustered or group loading.

A single central chassis spine variant is depicted in FIGS. 11A and 11B, with appropriate adaptation of various key features of the twin longitudinal chassis rails variant of FIGS. 1 through 10B, such as the transverse members and selectively deployable lateral load restraints.

Essentially, a central chassis spine 51 is fitted with a series of spaced opposed pairs of tubular transverse stub branch members 52, carrying at their ends respective lateral restraint members 54. The overall configuration is of a fishbone or backbone, with an array of longitudinally spaced ribs.

The lateral restraints 54 can be swung individually (through an arc 61 about the associated transverse stub tube 52, as depicted in broken lines 63), between a collapsed condition, lying generally alongside and within the depth of the chassis spine 51, and an upright condition (as depicted in solid line).

The stub tubes 52 are set toward the bottom of the chassis spine 51, collectively to provide a recessed or sunken load bed or load support layer to either side.

The lateral restraints 54 may be pivoted at their lower ends to the associated transverse stubs 62, or the stubs 52 themselves may be pivotally attached to the chassis spine 51.

Torsion springs (not shown) may be incorporated in, or fitted to act upon, the pivots, as a loading counterbalance, facilitating (manual)erection or collapse, or biassing the respective members 54 into one condition or another, as indicated by rotary arrow 65. Thus the stubs 52 could act as a form or torque tube.

Similarly, latches (not shown) may be fitted to secure the members 54 into a given condition or orientation.

End gates 58 are carried upon pivots 59 at the outward ends of splayed chassis bracing extensions 56 at the ends of the chassis spine 51, with recesses 57 in whose upper end surface accommodate the folded over end gates 58.

Inward folding for compact collapse, of an end gate 58 is depicted in FIG. 11B, by arcuate arrow 65.

### Component list

10 container

11 (longitudinal) chassis rail

12 (longitudinal) chassis rail

14 corner end post

15 corner end post

16 log cargo

17 corner plate

18 lateral restraint (post/strut)

19 transverse deck beam

20 load deck

21 tine slot

22 pivot

23 latch

24 end barrier/gate

26 abutment/stop

26 pivot bearing

27 bracket

28a/b telescopic restraint (collapsed/extended)

29 latch

30 U-frames

31 V-section valley

32 notch

33 recessed tray/trough/well

34 profiled spacer

35 profiled spacer

36 pivot axle

37 mounting pin

38 bracing tie

39 load tie

41 lateral wedge

42 notch piece

43 full-width tray/trough/well

44 profiled spacer

45 profiled spacer

46 mounting fitting

51 chassis spine

52 transverse stub branch

54 lateral restraint

56 splayed end support

57 recess

58 end gate

59 pivot

61 arc

63 transitional position between erection and collapse

65 stub tube rotation

66 end gate folding

1. A dedicated elongate cargo container (10) comprising a load bed (11), lateral restraints (15), along opposite sides of the load bed, corner end posts (14, 15), at, or adjacent, each corner of the load bed, the lateral restraints being (re-)movable, to facilitate cargo (16) stacking upon the load bed.

2. A container, as claimed in claim 1, having a pair of spaced chassis rails, with intervening transverse spacers, in a ladder frame configuration, and lateral restraints carried as outriggers, outboard of the chassis rails.

3. A container, as claimed in claim 1, having single central chassis spine, with transverse members configured as branch stubs on either side, supporting lateral restraints.

4. A container, as claimed in claim 3, with transverse members carrying pivot supports at their outboard ends for respective lateral restraints.

5. A container, as claimed in claim 3, with transverse members pivotally attached to the chassis spine, to provide rotation of associated lateral restraints carried at their outboard ends.

6. A container, as claimed in claim 3, with transverse members configured as tubes, and torsion bias springs and latches being fitted to facilitate erection and collapse of lateral restraints carried at their outboard ends.

7. A container, as claimed in any of the preceding claims, with an elongate load bed, and longitudinally-foldable lateral restraints, movable between an upright erected condition, and a folded condition, lying over, alongside or within the depth or span of the load bed.

8. A container, as claimed in claim 7, with a common drive linkage for coordinated erection and collapse of multiple restraints.

9. A container, as claimed in any of the preceding claims, including lateral restraints in opposed pairs, with a transverse bracing member there-between.

10. A container, as claimed in claim 1, including transversely-foldable lateral restraints, movable between an upright erected condition, and a folded condition, lying across the load bed.

11. A container, as claimed in any of the preceding claims, incorporating a load recess or well, in the load bed, to lower the load centre of gravity and/or contribute lateral load restraint.

12. A container, as claimed in any of the preceding claims, incorporating a profiled load bed cross-section, for lateral load restraint.

13. A container, as claimed in any of the preceding claims, incorporating a hinged and/or removable end gate at an end of the load bed.

14. A container, as claimed in claim 13, with chassis recess, or stepped profile, to accommodate a folded end gate.

15. A container, as claimed in any of the preceding claims, with a chassis recess, or stepped profile, to accommodate folded or removed lateral restraints.

16. A container, as claimed in any of the preceding claims, wherein a load bed or load support platform and the erected or collapsed span of end posts, transverse support beams, and lateral restraints fit collectively within, or are bounded to conform to, a prescribed overall containerisation load envelope standard, for stacking and/or inter-nesting inter-fit with other similar such containers, either when erected or collapsed.

17. A container, substantially as hereinbefore described, with reference to, and as shown in, the accompanying drawings.
